(19) United States
(12) Patent Application Publication
(10) Pub. No.: US 2002/0118389 A1
(43) Pub. Date: Aug. 29, 2002

(54) Image data communication system and image data communication method

(76) Inventors: Yasuo Fukuda, Kanagawa (JP); Miyuki Enokida, Kanagawa (JP)

Correspondence Address: FITZPATRICK CELLA HARPER & SCINTO, 30 ROCKEFELLER PLAZA, NEW YORK, NY, 10112, US

(21) Appl. No.: 10/078,454

(22) Filed: Feb. 21, 2002

(30) Foreign Application Priority Data
Feb. 27, 2001 (JP) 052567/2001

(51) Int. Cl. G06F 15/00

(52) U.S. Cl. 358/1.15

(57) ABSTRACT

An image data communication system having: a plurality of server computers for providing at least one of a plurality of stored image data; and at least one client computer for requesting one of the plurality of server computers to provide the image data. Each server computer has selecting means for, when the request is received from the client computer, selecting the server computer which can cope with the request and transmitting means for transmitting access information for accessing the selected server computer to the client computer. The client computer has obtaining means for, when the access information is received, obtaining the image data from the server computer corresponding to the access information.

### BACKGROUND OF THE INVENTION

1. Field of the Invention

The invention relates to an image data communication system and an image data communicating method, by which image data is transmitted and received via a network.

2. Related Background Art

On the Internet, processes for accessing a WWW (World Wide Web) server from a Web browser and viewing document data, image data, or the like are frequently executed. According to such a mechanism, there are the WWW server for releasing information onto the Internet and clients who view the information exist, and the client side views the information on the WWW server by using the Web browser. A document called a Homepage in which information which the server wants to release has been described in an HTML (Hypertext Markup Language) has been stored in the WWW server. The Web browser on the client side displays such a document onto a client computer. The Web browser on the client side can obtain the information which he needs by tracing a link in a displayed page.

Between the server and the client, the WWW server and the Web browser communicate by using an HTTP (Hypertext Transfer Protocol) and operate as follows in such a protocol.

For example, when the user on the client side clicks a portion where link information in a certain page has been stored, the Web browser decodes the link information in the clicked portion and opens a new URL (Uniform Resource Locator). Such an opening operation denotes an operation for issuing a request to the WWW server. The WWW server which received such a request returns a corresponding document to the client. The document which is sent from the WWW server is constructed by header information and a document main body. The Web browser on the client side analyzes the header information of the document sent from the WWW server. Specifically speaking, from MIME (Multipurpose Internet Mail Extensions) TYPE existing in the header information, application software to open a subsequent document is determined. After that, the determined application software is activated and the document main body existing after the header information is transferred to the application software, and the document is displayed.

As mentioned above, in the HTTP, fundamentally, when an opening request of a certain URL is transmitted from the client side to the WWW server side, the WWW server side sends the document main body designated by the URL to the client.

On the other hand, in an IIP (Internet Imaging Protocol) which is used when an image data file is displayed, fundamentally, substantially the same operation as that in case of using the HTTP is executed, the image data or the like is received by the WWW server by using the IIP, and a process such as display or the like is performed. However, in the IIP, the image data to be displayed is a partial image of the image data stored in the WWW server. As a request from the client side, for example, there is a request for enlargement, reduction, panning, or the like. Each time such a request is made, the request is issued to the WWW server. As mentioned above, according to the IIP, the processes are not finished by one request, but the request is issued several times.

Generally, processes regarding an image are heavier than those in case of processing, for example, a text or the like, so that there is a problem such that it is a load on a server machine. This results in that an influence is exercised on a response speed to the client, that is, the user.

To reduce the load on the server machine, there is a method of improving processing ability of the server machine itself. However, no effect is obtained when there are requests exceeding the improved processing ability. Although a method of increasing the number of server machines is also effective, the server side cannot manage to which server the user actually transmits the request. For example, in a situation such that accesses are concentrated on a specific server since the server is well-known for various reasons such that the server itself has a long history, and the like, there is a case where the effect which is obtained by the increase in number of server machines cannot be expected.

In the IIP, in case of issuing the request to the WWW server a plurality of times, there is a problem such that since the Web browser makes the first request and since the URL of the WWW server exists in, for example, an HTML document on the link destination side, the request can be made to the WWW server, while since application software such as “plug-in” which is activated in accordance with MIME-TYPE by the second and subsequent requests receives only the document main body of the data (image data) sent from the WWW server as a result of the first request, the URL of the WWW server to be connected cannot be known.

To solve such a problem, there is a method of embedding the operation and requests into the HTML document. However, if such a method is used, the operation to form the HTML document becomes complicated.

There is also a method whereby the plug-in software of the Web browser inquires of the Web browser about to which WWW server the request has been issued and extracts the URL. In this case, since a process for inquiring of the Web browser about the URL is necessary and, further, an inquiring method also differs every Web browser, there is a problem such that the process becomes complicated and it takes development costs.

Moreover, it is also possible to use a method whereby dedicated application software is formed besides the Web browser and, in such application software, the user is allowed to input the URL of the WWW server by a dialog or the like. However, such a method also has a problem such that since the dedicated application software has to be developed, it takes development costs.

On the server side, a size of image data which is managed or the number of images increases and, in case of using one server machine, it is impossible to respond smoothly to requests from a plurality of clients. In this case, although they are usually managed by a plurality of server machines, if a plurality of image files are simply divided and stored into a plurality of server machines, the link information in the homepage has to be rewritten.

### SUMMARY OF THE INVENTION

The invention is made by paying attention to those problems and it is an object of the invention to provide an image data communication system, an image data communicating method, and a memory medium, in which in case of receiving image data from a server, a load to the server can be reduced as much as possible.

Another object of the invention is to provide an image data communication system, an image data communicating method, and a memory medium, in which in case of issuing a request to a server a plurality of times in response to a request from the user, a URL of the second or subsequent time can be easily known.

To accomplish the above objects, according to the invention, there is provided an image data communication system comprising: a plurality of server computers for providing at least one of a plurality of stored image data; and at least one client computer for requesting one of the plurality of server computers to provide the image data, wherein each of the server computers has selecting means for, when the request is received from the client computer, selecting the server computer which can cope with the request and transmitting means for transmitting access information for accessing the selected server computer to the client computer, and the client computer has obtaining means for, when the access information is received, obtaining the image data from the server computer corresponding to the access information.

The above and other objects and features of the present invention will become apparent from the following detailed description and the appended claims with reference to the accompanying drawings.

### BRIEF DESCRIPTION OF THE DRAWINGS

FIG. 1 is a system constructional diagram of an image data communication system according to the first embodiment of the invention;

FIG. 2 is a block diagram showing a construction of a server computer in FIG. 1;

FIG. 3 is a diagram showing a procedure for communication between a server and a client and an outline of communication information at that time;

FIG. 4 is a diagram showing an example of specific data contents of a document in FIG. 3;

FIG. 5 is a diagram showing an example of a correspondence table which is used for selecting the server near the client on a network;

FIG. 6 is a flowchart showing a procedure for a URL forming process which is executed by the server in FIG. 1, particularly, a CPU;

FIG. 7 is a diagram showing an example of a response of the server which returns a plurality of URLs;

FIG. 8 is a diagram showing an example of tables which are used for selecting the server near the client on the network;

FIG. 9 is a flowchart showing a procedure for a server deciding process which is executed by a client computer in FIG. 1, particularly, the CPU;

FIG. 10 is a diagram showing another example of a response of the server which returns a plurality of URLs;

FIG. 11 is a system constructional diagram of an image data communication system according to the third embodiment of the invention;

FIGS. 12A and 12B are diagrams showing relations between each layer which is obtained in case of layer-encoding and image sizes;

FIG. 13 is a diagram showing a procedure for communication between a server and a client and an outline of communication information at that time;

FIG. 14 is a flowchart showing a procedure for a data transmitting process which is executed by a low resolution server;

FIG. 15 is a flowchart showing a procedure for a data transmitting process which is executed by a high resolution server;

FIG. 16 is a diagram showing transition of an IIP; and

FIG. 17 is a flowchart showing an example of the operation which is executed by the low resolution server.

### DESCRIPTION OF THE PREFERRED EMBODIMENTS

Embodiments of the invention will be described in detail hereinbelow with reference to the drawings.

(First Embodiment)

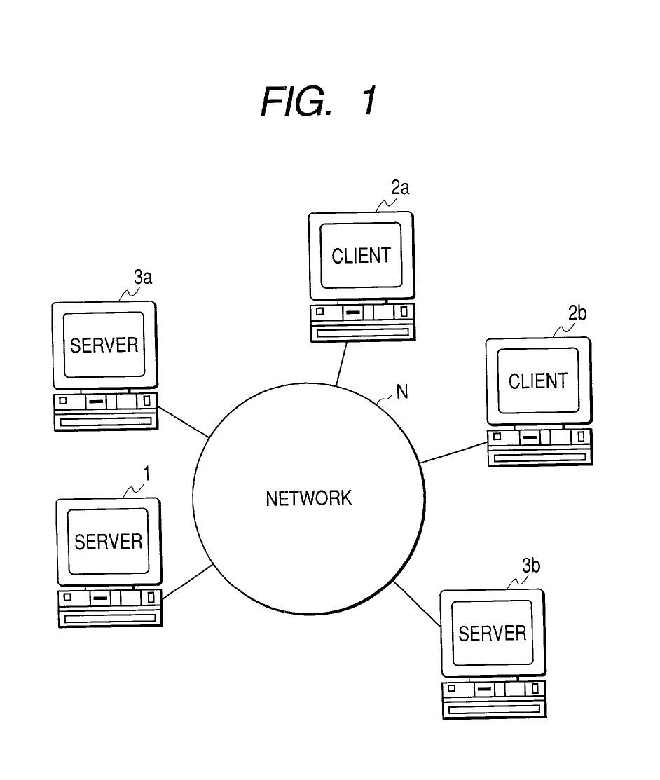

FIG. 1 is a system constructional diagram of an image data communication system according to the first embodiment of the invention. The image data communication system of the embodiment is constructed by a plurality of computers 1, 2a, 2b, 3a, and 3b connected to a network N represented by the Internet.

In the diagram, the computers 1, 3a, and 3b are server computers in which not only an IIP server for transmitting Flashpix image data but also software necessary for a WWW server function have been installed. A large amount of image data has also been stored in the servers 1, 3a, and 3b.

The computers 2a and 2b are client computers in which software such as a Web browser and the like necessary on the client side has been installed.

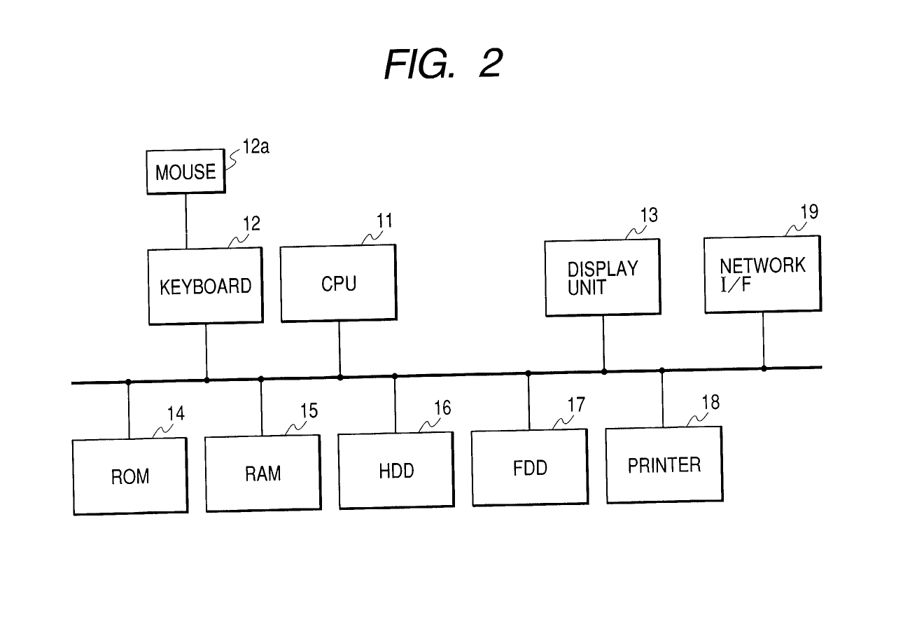

FIG. 2 is a block diagram showing a construction of the server computer 1.

The server computer 1 is constructed by: a CPU 11; a keyboard 12; a mouse 12a; a display unit 13; an ROM 14; an RAM 15; a hard disk drive (HDD) 16; a floppy disk drive (FDD) 17; a printer 18; and a network interface 19.

The CPU 11 performs a control and the like of the whole system.

The keyboard 12 is used for inputting information or the like to the system in cooperation with the mouse 12a.

The display unit 13 is constructed by a CRT, a liquid crystal display, or the like.

The ROM 14 and RAM 15 construct a storing device of the system and store programs which are executed by the system and data which is used by the system.

The HDD 16 and FDD 17 construct an external storing device which is used in a file system of the system.

The network interface 19 controls connection to the network N in FIG. 1.

Other computers 2a, 2b, 3a, and 3b are also constructed in a manner similar to the server computer 1 in FIG. 2.

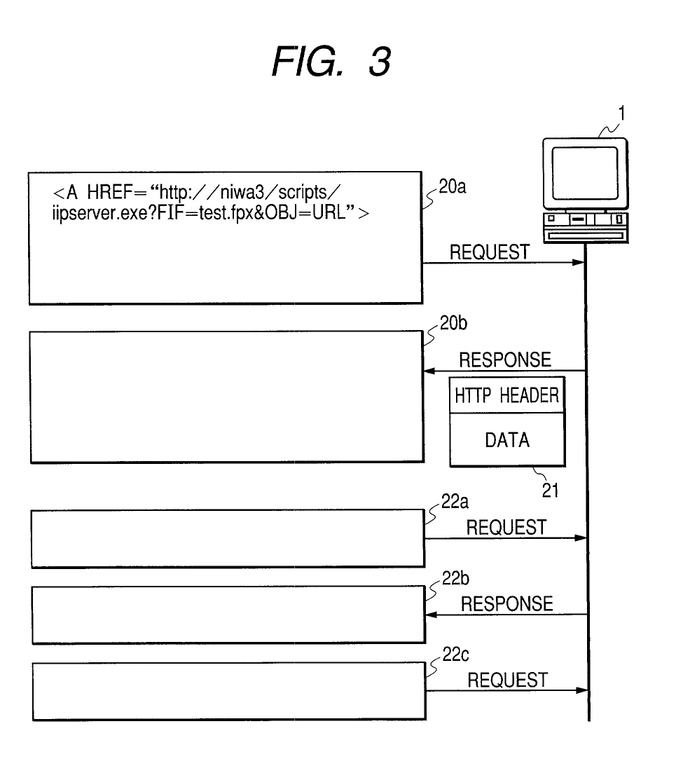

Subsequently, it is assumed that the image data stored in the server computer 1 is, for example, a Flashpix file. The operation which is executed when the Flashpix file is accessed from the client side via the Internet N and displayed will be described with reference to FIG. 3. In the embodiment, an example in the case where the three server computers 1, 3a, and 3b and one client computer 2a operate will now be described.

The servers 1, 3a, and 3b hold at least one Flashpix file of the same contents. The URL of the corresponding Flashpix file of another server can be easily specified from each Flashpix file held in one of those servers. It is sufficient that, for example, among all of the servers 1, 3a, and 3b, all of the corresponding Flashpix files have the same file name. It is also possible to add a well-known database into each of the servers 1, 3a, and 3b, thereby enabling the corresponding Flashpix file of another server to be easily searched.

FIG. 3 is a diagram showing a communicating procedure between the server and the client and an outline of communication information at that time.

First, it is assumed that a page in which link information to the Flashpix file has been written is displayed onto the Web browser of the client, and the user clicks a portion of the link by using a pointing device such as a mouse 12a or the like. At this time, since a command “OBJ=URL” for the IIP server has been written in the link information, a command train is issued as a request 20a from the client side to the server on the basis of the URL written in the link information.

Subsequently, the server which receives the request 20a discriminates whether there is “OBJ=URL” in the transmitted command train or not. The server returns a response 20b together with a corresponding document 21 to the Web browser of the client who issued the request.

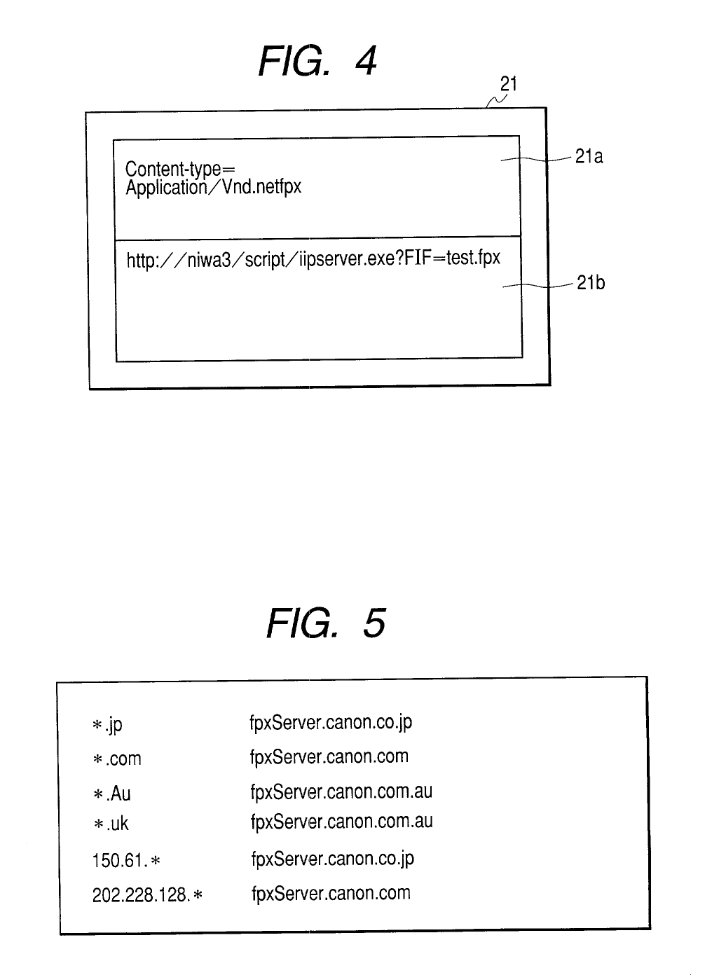

FIG. 4 is a diagram showing an example of specific data contents of the document 21.

In the diagram, the document 21 is constructed by a header portion 21a and a document main body 21b. “Content-type” has been stored in the header portion 21a. On the other hand, if the command “OBJ=URL” exists in the command train although it is inherently the document main body, as a response of the server to the present request, the URL used when this request is issued from the client side has been stored as it is in the document main body 21b. If such a command does not exist, no URL is inserted. In the embodiment, the URL is inserted into the document main body.

After that, the Web browser on the client side who receives the document 21 analyzes the header portion 21a in the document, looks at “Content-type” stored therein, determines application software corresponding to the document of this “type”, activates such application software, and transfers the document main body 21b to the activated application software. The activated application software or the plug-in software starts the operation. In the embodiment, it is assumed that the plug-in software of the Web browser is activated.

In the embodiment, since the link for displaying the Flashpix file has been clicked, the plug-in software which is activated is plug-in software for displaying the Flashpix file stored in the server via the network N. The activated plug-in software can extract the URL of the server which makes communication from now on from the document main body 21b transferred from the Web browser. After that, communication is made between the plug-in software on the client side and the server.

Subsequently, the activated plug-in software for displaying the Flashpix file operates in a manner such that image information of the Flashpix file which is displayed at this time is requested to the server, that is, image information corresponding to the image data such as color space, image size, the number of layers, and the like is requested to the server (request 22a), after that, when a response 22b to the request 22a is received, a tile number of a necessary portion of desired resolution is arithmetically operated in the software, they are again requested to the server (request 22c), and thereafter, actual tile data is obtained and displayed.

After that, in accordance with the operation of the user, specifically speaking, the enlargement, reduction, scroll, etc., the operation such that a tile number of the resolution that is necessary for the present display in the image data is requested to the server, and after the data is received, it is displayed is repeated.

The embodiment is realized by adding the following processes into such a communication procedure process of the IIP. That is, the server receives the request 20a in FIG. 3, discriminates whether “OBJ=URL” exists in the transmitted command train or not, selects the server to be accessed next by the client 2a from the position of the client 2a on the network N and the positions of the servers 1, 3a, and 3b on the network N in accordance with the command “OBJ=URL”, and forms the URL corresponding to the selected server by the following procedure.

As mentioned above, the URL of the Flashpix file corresponding to the other server 3a or 3b can be easily formed from the URL of the Flashpix file of the server 1. For example, assuming that

Host name of the server 1: fpxServer.canon.co.jp

Host name of the server 3a: fpxserver.canon.com

Host name of the server 3b: fpxServer.canon.com.au

the URL of the IIP request at the time when the Flashpix file of “test.fpx” is requested by the client to the server 1 is, for example, as follows.

HYPERLINK http://fpxServer.canon.co.jp/cgi-bin/iipserver.cgi?OBJ=URL&FIF=test.fpx . . . http://fpxServer.canon.co.jp/cgi-bin/iipserver.cgi?OBJ=URL&FIF=test.fpx . . .

The server 1 can return this URL as it is or can also return the corresponding URL of the server 3a or 3b. For example,

HYPERLINK http://fpxServer.canon.co.jp/cgi-bin/iipserver.cgi?OBJ=URL&FIF=test.fpx . . . http://fpxServer.canon.com/cgi-bin/iipserver.cgi?OBJ=URL&FIF=test.fpx . . . (URL of the server 3a)

HYPERLINK http://fpxServer.canon.co.jp/cgi-bin/iipserver.cgi?OBJ=URL&FIF=test.fpx . . . http://fpxServer.canon.com.au/cgi-bin/iipserver.cgi?OBJ=URL&FIF=test.fpx . . . (URL of the server 3b)

As mentioned above, since the client issues the next request on the basis of the URL which is returned by the server, the server to be accessed by the client can be switched to another server by this method.

At this time, which server is selected is determined on the basis of the position of the client on the network N and the position of each server on the network N. Since the server 1 communicates with the client 2a, an IP address and a host name of the client 2a have been known, so that the position on the network N can be grasped. By previously writing the positions of other servers 3a and 3b on the network N into the server side, they can be also grasped. Therefore, the server to be accessed next is selected from the positional relation between them on the network N. For example, by selecting the server such that a distance from the client on the network N is the closest, it is possible to expect that the nearer the distance on the network N is, the higher the communication performance is. Therefore, it is possible to expect that the server can respond to the request from the user at a higher speed. Various methods of realizing it are considered. For example, it is sufficient to preliminarily form a correspondence table as shown in FIG. 5.

In the correspondence table in FIG. 5, each line is constructed by a pair of a pattern of the IP address or host name of the client (hereinafter, such a pattern is referred to as a “client pattern”) and the host name of the server to be accessed. In the table of FIG. 5, “*” is included in the client pattern. It is assumed that it means a wild card and is matched with an arbitrary character train. The correspondence table is shown merely as an example and another table in an arbitrary format can be used so long as a correspondence relation between a mark belonging to the client pattern and the server to be ccessed can be described.

For example, in case of applying the table of FIG. 5 to a host name belonging to a domain of Japan such that the host name of the client 1 is “niwa.saitama.jp”, it is matched with a client pattern “*.jp” of the first line, so that the server 1 of “fpxSever.canon.co.jp” is selected and the URL of the server 1 is returned. If the host name of the client 2a is “daemon.cannon.co.uk”, it is matched with the fourth line, “fpxSever.canon.com.au” is selected, and its URL is returned. If the IP of the client is “150.61.1.1”, it is matched with the fifth line, “fpxSever.canon.co.jp” is selected, and its URL is returned. Further, if the IP of the client is “202.228.128.210”, it is matched with the sixth line, “fpxSever.canon.com” is selected, and its URL is returned.

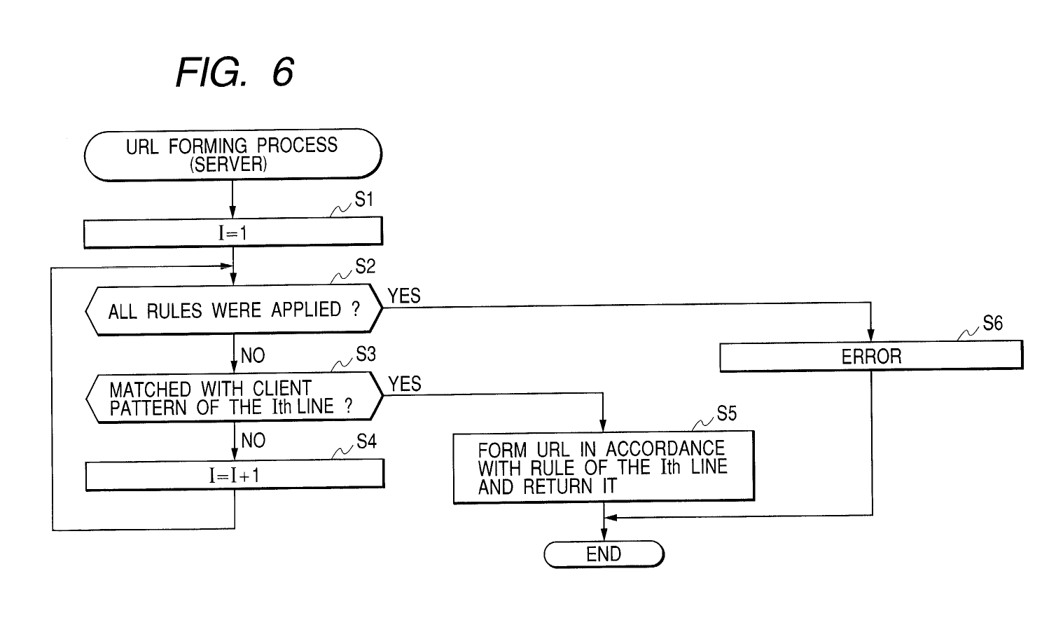

FIG. 6 is a flowchart showing a procedure for a URL forming process which is executed by the server, particularly, the CPU 11.

In the diagram, in step S1, first, an index I showing a line of a rule to be referred to is set “1”.

Subsequently, discrimination in step S2 is made. In case of the example of FIG. 5, since there are rules of six lines in total, if the index I is equal to or larger than “7”, a discrimination result in step S2 is “YES”. The processing routine advances to step S6 and ends as an error. In this case, the processing routine is finished by returning an error message to the client, or the like. If NO in step S2, discrimination in step S3 is subsequently made.

In step S3, whether the IP or host name of the client is actually matched with the client pattern of the Ith line or not is discriminated. If it is matched as mentioned above, the high resolution server is determined in accordance with the rule of the Ith line and the URL corresponding to it is formed and returned (step S5). After that, the processing routine is finished.

If it is not matched with the client pattern of the Ith line, the value of the index I is increased by “1” in step S4 and the processing routine is returned to step S2.

A rule “in the case where the client does not conform to any of the rules of the first to sixth lines” such as

* fpxserver.canon.com

can be also added to the end of the rules in FIG. 5. In this case, since the processing routine does not advance to step S6 in FIG. 6, the process in step S6 can be also omitted.

The reason why only the host names of the servers are described in the example of the table of FIG. 5 is because it is intended to simplify an explanation. For example, the host names and path information in actual/virtual file systems of the host names can be also included in the table. Although one high resolution server is disclosed in each line, the number of such servers is not limited to one. This is because, for example, even in the case where a plurality of servers are described in the rule, in step S5 of forming the URL, the URL can be selected by selecting one of those servers on the basis of a proper reference.

Although the same Flashpix file is stored into the servers 1, 3a, and 3b in the embodiment, for example, the image data communication system according to the invention can be also realized by a construction such that the server 1 is set to the low resolution server which holds the image data including at least one low resolution image in the Flashpix file data and the servers 3a and 3b are set to the high resolution servers which hold the image data including at least one high resolution image. For example, it is also possible to construct in a manner such that the number of layers of the Flashpix image is set to 3, the server 1 is set to the low resolution server which holds the images of layers 0 and 1, the servers 3a and 3b are set to the high resolution servers which hold the images of layers 0, 1, and 2, the requests for layers 0 and 1 are processed by the low resolution server 1, if the request for layer 2 is made to the low resolution server 1, a process similar to the URL forming process in FIG. 6 mentioned above is executed, and a proper one of the high resolution servers 3a and 3b is selected.

With such a construction, it is advantageous in distribution of a load in the case where many high resolution servers which handle high resolution images which generally become a heavy load on the server are arranged and a relatively small number of low resolution servers to which a relatively light load is applied are arranged.

On the contrary, it is also possible to construct in a manner such that the server 1 is set to the high resolution server which holds the image data including at least one high resolution image in the Flashpix file data, the servers 3a and 3b are set to the low resolution servers which hold the image data including at least one low resolution image, further, timing when the low resolution image is requested to the high resolution server 1 is used as a trigger, a process similar to the URL forming process in FIG. 6 mentioned above is executed, and a proper one of the low resolution servers 3a and 3b is selected.

With such a construction, in the case where the number of requests for the low resolution image in which, for example, display of a list of images or the like is intended is much larger than the number of requests for the high resolution image in which seeing the image in detail is intended, it is advantageous in distribution of a load in the case where many low resolution servers are arranged and a relatively small number of high resolution servers in which the number of requests is relatively small are arranged.

(Second Embodiment)

In the above first embodiment, when the command “OBJ=URL” is sent from the client, the server forms only one URL of the server to which the client should access next. The second embodiment, however, differs from the first embodiment only with respect to a point that a plurality of URLs are formed in such a case.

The invention according to the second embodiment, therefore, is realized by adding the following processes into the communication procedure process of the IIP described in the first embodiment. Specifically speaking, the server receives the request 20a in FIG. 3, discriminates whether the command “OBJ=URL” as a request for returning the URL exists in the transmitted command train or not, and returns a plurality of URLs to the client in response to the command “OBJ=URL”. The client which receives a plurality of URLs selects some of the URLs and transmits the request to the selected server.

The command “OBJ=URL” is merely shown as an example and any other character train can be used so long as the server is allowed to interpret it as a similar request.

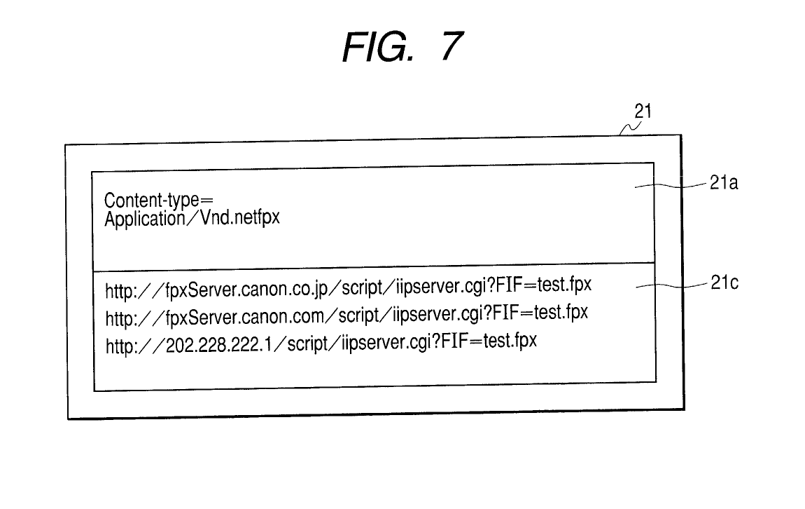

FIG. 7 is a diagram showing an example of a response of the server who returns a plurality of URLs.

In the diagram, although a plurality of URLs are written each on every line in a document main body 21c, it is merely shown as an example. Any format can be used so long as the client who receives the response can easily extract each URL.

The client who receives the response as shown in FIG. 7 selects some of the received plurality of URLs. For example, in the embodiment, one URL which seems to be close to the client in terms of the network is selected.

For example, the servers indicated by three URLs disclosed in the document main body 21c in FIG. 7 are, respectively, assumed to be

fpxServer.canon.co.jp: server 1

fpxServer.canon.com: server 3a

202.228.222.1: server 3b

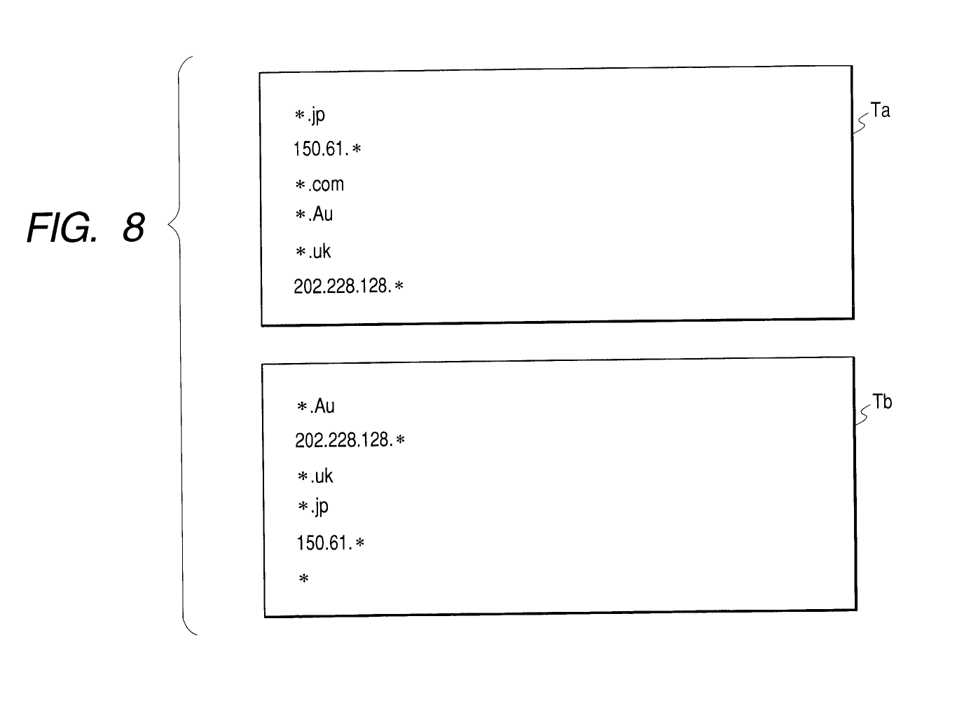

At this time, in the embodiment, which server is selected is determined on the basis of the position of the client on the network N and the positions of the servers 1, 3a, and 3b on the network N. Since the client 2a knows his own position on the network N, he selects the server to be accessed next from the positional relation on the network N which is presumed from the URL or host name of each server. For example, if the server locating at a short distance from the client on the network N is selected, it is possible to expect that the shorter the distance on the network N is, the higher the communication performance is. Therefore, it is possible to expect that a response is made to the user's request more quickly. There are various methods of realizing it. For example, it is sufficient that a correspondence table such as a table Ta or Tb in FIG. 8 is preliminarily formed on the client 2a or 2b side.

A list of patterns of the IP addresses or host names of the servers (hereinafter, referred to as “server patterns”) has been described in each line in the tables Ta and Tb in FIG. 8. In such a list, it is assumed that the higher the line is, the shorter the distance on the network N at the time when it is seen from the client side is. “*” is included in the server pattern in the example of the tables Ta and Tb. It means a wild card and denotes that it is matched with an arbitrary character train. Those correspondence tables are merely shown as examples and any format can be used so long as it belongs to the server pattern and an order can be described.

For example, it is assumed that the client 2a has a correspondence table like a table Ta and the client 2b has a correspondence table like a table Tb. It is assumed that a response including a plurality of URLs as shown in FIG. 7 is returned to the clients 2a and 2b.

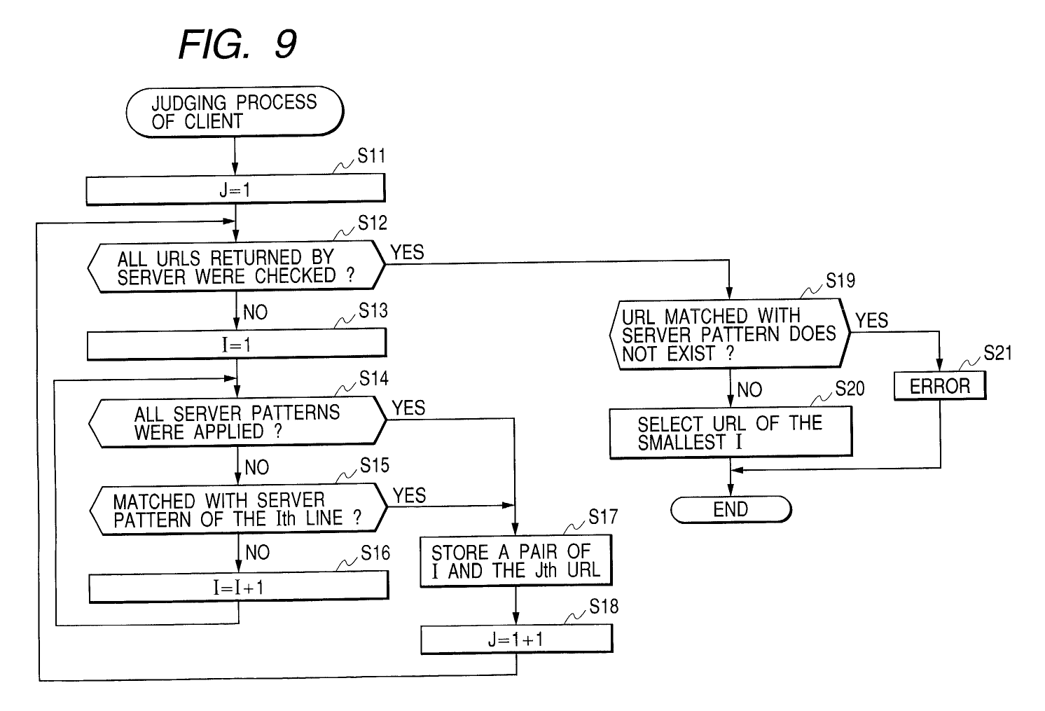

FIG. 9 is a flowchart showing a procedure for a server determining process which is executed by the client computer, for example, the CPU.

In the diagram, first, in step S11, an index J showing one of a plurality of URLs returned by the server is initialized to “1”.

Next step S12 is an end discriminating process. Whether processes in steps S13 and S18, which will be explained hereinlater, have been finished with respect to all of the URLs returned by the server or not is discriminated. For example, in case of the example of FIG. 7, since the number of URLs returned by the server is equal to 3, it is sufficient to discriminate whether the index J is equal to “4” or more or not.

In next step S13, the index I showing the line of the server rule is initialized to “1”. In step S14, whether all of the server patterns have been applied to the Jth URL or not is discriminated. In case of the table Ta in FIG. 8, since there are rules on six lines, it is sufficient to discriminate whether the index I is equal to “7” or more or not. If a discrimination result in next step S14 is “NO”, the processing routine advances to step S15. If “YES”, step S17 follows.

In step S15, whether the Jth URL is matched with the server rule of the Ith line or not is discriminated. If it is not matched, the processing routine advances to step S16 and the value of the index I is increased by “1”. After that, the processing routine is returned to step S14.

If it is matched, the processing routine advances to step S17 and a pair of the value of the index I and the Jth URL is stored. Further, in step S18, the value of the index J is increased by “1”. After that, the processing routine is returned to step S12.

If a discrimination result in next step S12 is “YES”, that is, if the check of all of the URLs is finished, the processing routine advances to step S19. In step S19, whether any one URL matched with the server pattern does not exist or not is discriminated. In case of the table Ta in FIG. 8, it is sufficient to discriminate whether the value of the index I for each URL is equal to “7” with respect to all of the URLs or not with regard to the pair of the value of the index I and the Jth URL stored in step S17. If a discrimination result in next step S19 is “NO”, in step S20, the URL in which the value of the index I is the smallest is selected with respect to the pair of the value of the index I and the Jth URL stored in step S17. The present processing routine is finished. If the discrimination result in next step S19 is “YES”, this means that with respect to all of the plurality of URLs returned by the server, the URL matched with the server pattern does not exist. Therefore, the processing routine advances to an error process in step S21 and, thereafter, the present processing routine is finished.

Specifically speaking, in case of the tables Ta and Tb, by the processes shown in the flowchart of FIG. 9,

Client 2a (Ta)

fpxServer.canon.co.jp:

matched with the 1st line of Ta

fpxServer.canon.com:

matched with the 3rd line of Ta

202.228.222.1:

matched with the 6th line of Ta

Client 2b (Tb)

fpxServer.canon.co.jp:

matched with the 4th line of Tb

fpxServer.canon.com:

matched with the 6th line of Tb

202.228.222.1:

matched with the 2nd line of Tb

The client 2a selects fpxServer.canon.co.jp, that is, the server 1, while the client 2b selects 202.228.222.1, that is, the server 3b.

In case of the table Ta, there can be also a case where all of the URLs which are returned by the server are not matched with the rules which the client side has. In this case, however, in the error process in step S21 in FIG. 9, it is possible to display an error to the user and finish the processing routine, or it is possible to select a proper one of the plurality of URLs returned by the server. For example, it is possible to select the URL of the first line in the document main body 21c in FIG. 7 as a response of the server.

Although the example in which the server and the client are connected via the Internet has been shown in the embodiment, such a construction in which they are connected via the Internet is not essential in the invention. For example, the invention can be easily applied to an LAN (Local Area Network) connection, a connection using a PPP (Point to Point Protocol), or the like by properly describing the rules as shown in the example in FIG. 8. Naturally, a construction in which the Internet and the LAN are equivalently used can be also realized by properly describing the rules as shown in the example in FIG. 8.

As mentioned above, the client side selects the server locating at the short distance on the network from among the plurality of URLs returned by the server, so that the load on the server can be distributed. In the embodiment, by selecting the server at a short distance on the network, it is possible to expect that the performance of the communication with the server is high, so that there is also an advantage such that it is possible to expect that the server can respond to the user's request at a higher speed.

Although only one server is selected on the client side in the embodiment, the invention is not limited to such an example but two or more servers can be also selected.

For example, although the client 2a has selected the server 1 in accordance with the response of the server as shown in FIG. 7 with reference to the rules as shown in the table Ta in FIG. 8 in the embodiment, the server is determined by a method similar to that in the embodiment and with respect to the selection of the servers, two servers locating at near positions of the distance on the network are selected. In this case, by applying the rules in the table Ta in accordance with the response in FIG. 7, in a manner similar to the embodiment,

Client 2a (Ta)

fpxServer.canon.co.jp:

matched with the 1st line of Ta

fpxServer.canon.com:

matched with the 3rd line of Ta

202.228.222.1:

matched with the 6th line of Ta

and the servers 1 and 3a are selected.

Therefore, if the requests to be subsequently transmitted by the client include the request for a plurality of images, by distributing the requests to the servers 1 and 3a, the load on the server side can be distributed. Particularly, in case of the image such that the image is divided into tile-shaped images like a Flashpix image format and can be handled on a tile unit basis, it is also possible to distribute the requests on a tile unit basis and distribute the load on the server side.

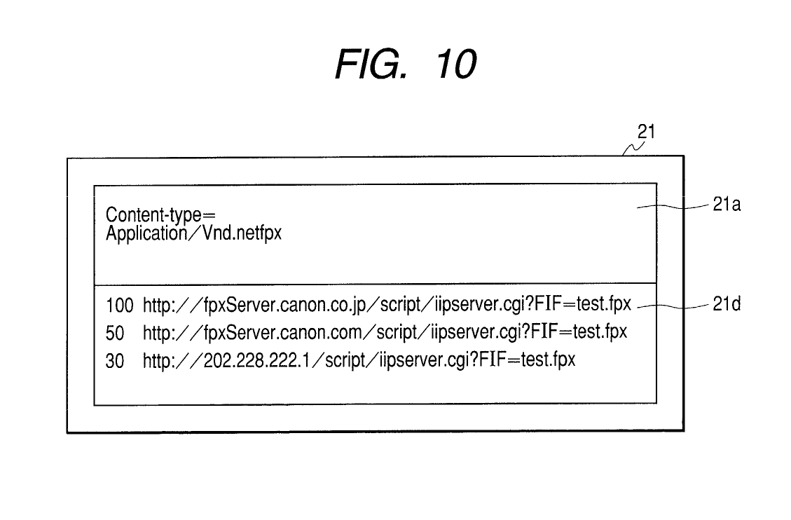

In the embodiment, although the example in which the server returns the response as shown in FIG. 7 has been mentioned, the invention is not limited to it. It is also possible to construct the system in a manner such that the server side adds priority information for each URL, for example, a response as shown in FIG. 10 is returned, and the client selects the server in accordance with the priority information.

The server obtains several URLs and the priority information for each URL in response to the request by the “OBJ=URL” command of the client 2a, forms the response as shown in FIG. 10, and returns it to the client. For instance, in the example of FIG. 10, a pair of a numerical value indicative of the priority information and the URL is described one line by one into a document main body 21d. To which one of the URLs in which the numerical values showing the priority information are large and small an access should preferentially be accessed can be set by preliminarily deciding an order between the server and the client. In this case, it is assumed that the larger the numerical value showing the priority information is, the more preferentially the server is accessed.

The response in FIG. 10 is merely shown as an example. Any format can be used so long as the client who receives the request can easily extract each URL and its priority information.

The numerical value showing the priority information can be previously statistically determined on the server side in accordance with request processing ability or the like of each server, or it is also possible to construct in a manner such that a process for grasping a load situation of each server is provided for the server side and such a numerical value is dynamically determined in accordance with a load situation of each server.

A well-known method can be used as a method of grasping the load situation of each server. For example, an uptime command of UNIX is outputted as follows.

1:23PM up 3:40, 4 users, load averages:

0.03, 0.05, 0.12

The last three numerals subsequent to “load averages:” in this output denote average loads of recent 1 minutes, 5 minutes, and 15 minutes, respectively. The smaller the numerical value indicative of the average load is, the smaller the load is. Contrarily, the larger the numerical value is, the larger the load is. Therefore, the numerical value showing the priority information can be dynamically determined by allocating the high priority information value to the server in which the average load value is small and, contrarily, by allocating the low priority information value to the server in which the average load value is large.

The client who receives the response as shown in FIG. 10 selects the URL from a plurality of URLs in accordance with the priority information. For example, he selects one URL in which the numerical value showing the priority information is the highest. Thus, in the response in FIG. 10,

HYPERLINK http://fpxServer.canon.co.jp/cgi-bin/iipserver.cgi?OBJ=URL&FIF=test.fpx . . . http://fpxServer.canon.co.jp/script/iipserver.cgi?FIF=test.fpx . . .

existing on the first line of the document main body 21d is selected. The client transmits the request for the image to fpxServer.canon.co.jp, that is, the server 1.

As mentioned above, the client side selects the server in accordance with the priority on the server side, so that the load on the server can be preferably distributed.

Although the number of URLs which are selected by the client side has been set to 1 in the above example, the invention is not limited to it but the client can also select a plurality of URLs.

For instance, although one URL in which the numerical value showing the priority is high has been selected in the embodiment, two URLs in which the numerical values showing the priorities are high can be also selected. In this case, in the example of FIG. 10, since

fpxServer.canon.co.jp:

the numerical value showing the priority is 100

fpxServer.canon.com:

the numerical value showing the priority is 50

202.228.222.1:

the numerical value showing the priority is 30

fpxServer.canon.co.jp and fpxserver.canon.com are selected.

In this case, the requests for a plurality of images can be also distributed to the two selected URLs. Particularly, in case of the image such that the image is divided into tile-shaped images like a Flashpix image format, it is also possible to distribute the requests on a tile unit basis and distribute the load on the server side.

Further, a ratio of the distribution can be also determined in accordance with the numerical value showing the priority. For example, in case of FIG. 10, since

(The priority value of fpxServer.canon.co.jp):

(The priority value of fpxServer.canon.com)=

100:50=

2:1,

the requests can be distributed to

fpxServer.canon.co.jp and fpxserver.canon.com at such a ratio, or the like. Thus, many requests are sent to the server with the high priority and, contrarily, a small number of requests are sent to the server with the low priority. The load can be further preferably distributed.

(Third Embodiment)

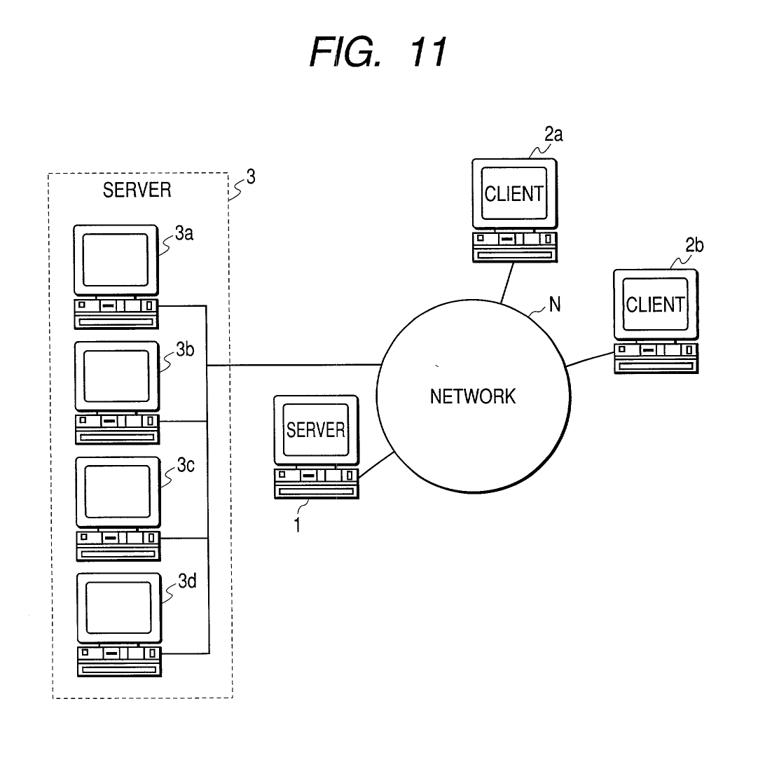

FIG. 11 is a system constructional diagram of an image data communication system according to the third embodiment of the invention.

In the diagram, component elements similar to those in FIG. 1 are designated by the same reference numerals.

As will be understood by comparing FIG. 11 with FIG. 1, the number of server computers in the system of FIG. 11 is larger than that of the system of FIG. 1 by 2.

In FIG. 11, the server computer 1 is a low resolution server for storing an image data file of low resolution. Each of the server computers 3a to 3d is a high resolution server for storing the same image data file of high resolution. A large amount of image data has also been stored in the server computers. Reference numerals 2a and 2b denote the client computers in which software such as a Web browser and the like which are necessary on the client side have been installed.

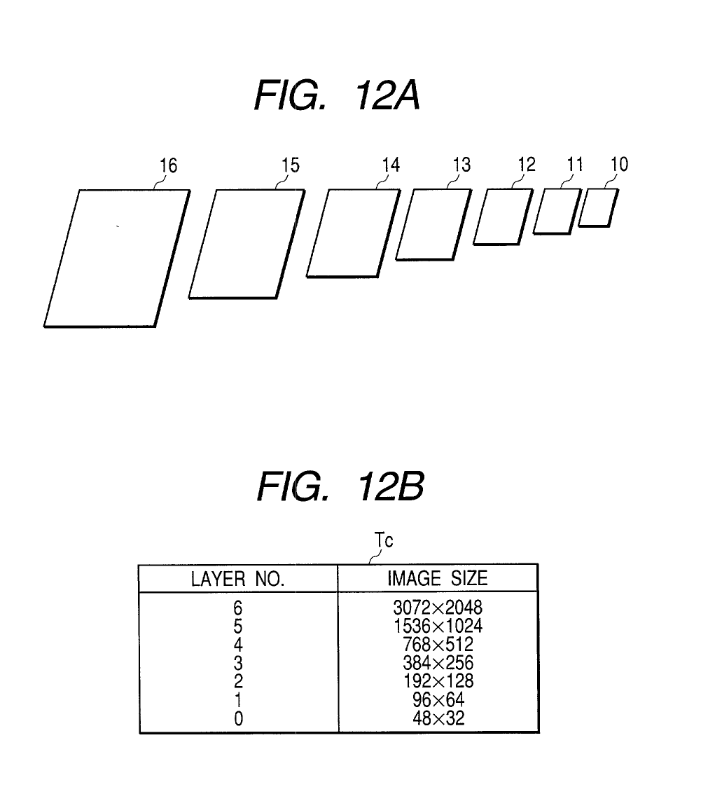

FIGS. 12A and 12B are diagrams showing relations between each layer which is obtained in case of layer-encoding and image sizes.

In the diagram, for example, a case where the image size of the maximum resolution is set to 3072×2048 and Flashpix is used as an image data file format will now be considered. In this case, the number of layers is equal to “7” and a correspondence relation between the layer number of each layer and the image size is shown in a table Tc. The layer No. 0 indicates the lowest resolution and corresponds to an image I0 having an image size (48×32). Similarly, the layer No. 1 corresponds to an image I1 having an image size (96×64). The layer No. 2 corresponds to an image I2 having an image size (192×128). The layer No. 3 corresponds to an image I3 having an image size (384×256). The layer No. 4 corresponds to an image I4 having an image size (768×512). The layer No. 5 corresponds to an image I5 having an image size (1536×1024). The layer No. 6 indicates the maximum resolution and corresponds to an image I6 having an image size (3072×2048).

As mentioned above, the Flashpix files accumulated into the file in a layer manner are managed by the low resolution server with respect to up to the images of the layer No. 2 and the image size of (192×128). It is assumed that all of the data of all of the layers has been accumulated in the high resolution server. It is also assumed that the same image data file has been accumulated in all of a plurality of high resolution servers. Further, it is assumed that the image file corresponding to the same image data has been accumulated in the low resolution server and high resolution server. It is also assumed that the low resolution server and the high resolution server communicate with each other and transmit and receive their own information.

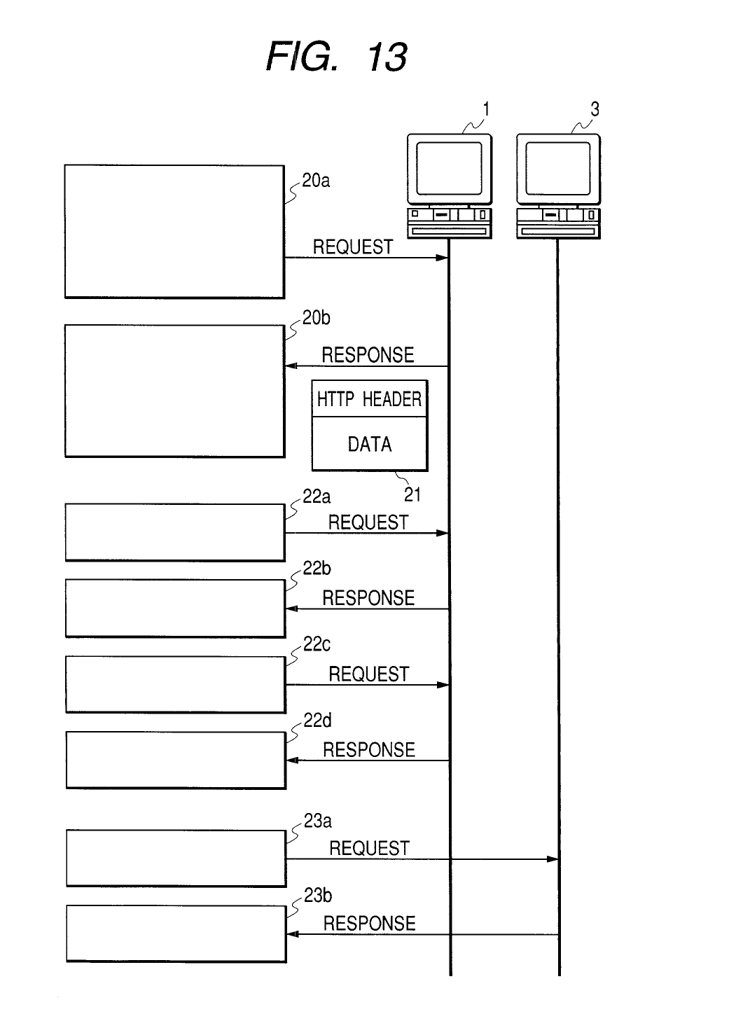

Since the image data stored in the server computers 1 and 3a to 3d is a Flashpix file, the operation which is executed when this Flashpix file is accessed from the client side via the Internet and displayed will now be described with reference to FIG. 13. In the embodiment, it is assumed that the server machine operates only in the low resolution server 1 and the high resolution servers 3a to 3d and the client machine operates only in the client machine 2a.

FIG. 13 is a diagram showing a procedure for communication between the server and the client and an outline of communication information at that time.

It is now assumed that as image data which is displayed first by, for example, the plug-in software on the client side, the image of the layer No. 2 is displayed. In this case, the plug-in software requests the server 1 to issue the image data by using the URL returned by the response to the first request.

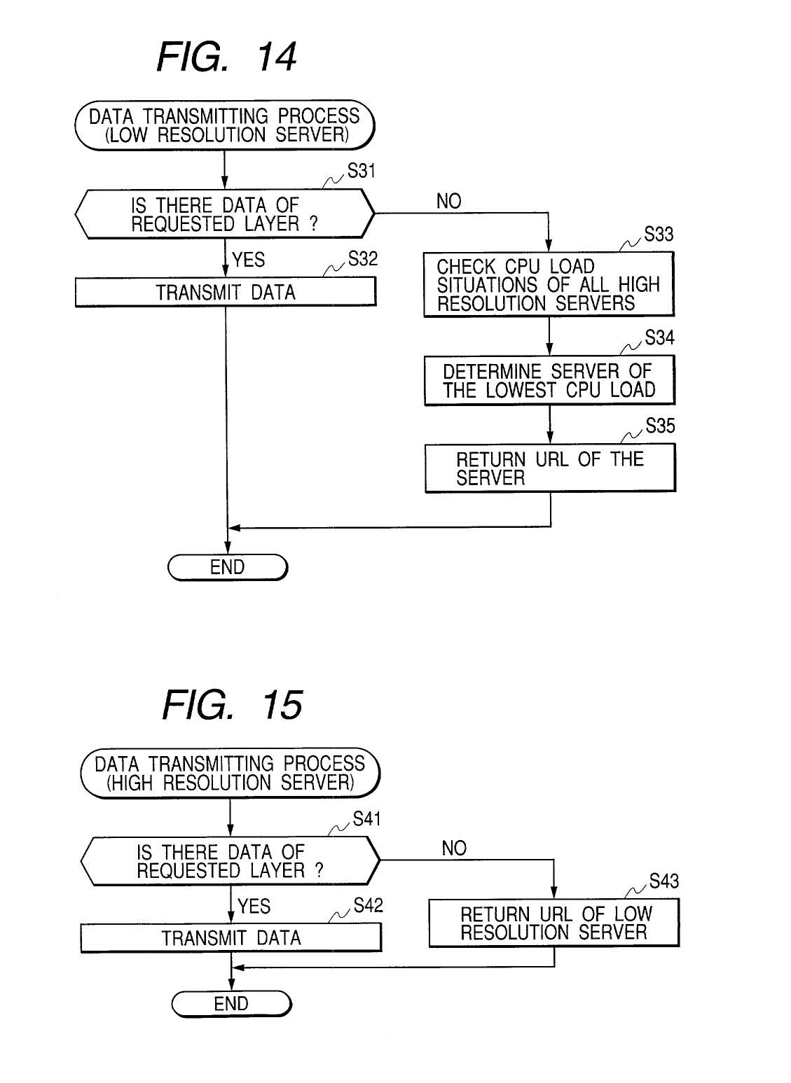

The low resolution server 1 which receives the request for the image data executes a data transmitting process of a flowchart shown in FIG. 14.

In the diagram, first, in step S31, whether the data of the layer requested by the client side at present exists in the low resolution server or not is discriminated. In the present case, since the layer No. is equal to 2, this low resolution server has the data of this layer, the processing routine advances to step S32. A process for reading the file or the like is executed. The requested image data is transmitted to the client side.

If the data of the requested layer does not exist, step S33 follows. In step S33, a CPU load situation of each of the plurality of high resolution servers is examined. For example, if the server machine is a UNIX machine, since an “uptime” command exists, this command is issued to the high resolution server machine by a remote command or the like. Thus, information such as

2:24PM up 7 days, 23:58, 7 users, load averages: 1.22, 0.79, 0.60

or the like is returned from each server machine. In step S34, by sorting the numerical values sequel to “load averages:” in this information in ascending order, the machine in which the load on the CPU is smallest can be determined.

In step S35, the URL of the high resolution server in which the CPU load is smallest is formed and returned to the client machine.

The plug-in software on the client side can receive and display the actual image data. After that, it is assumed that the user issued an enlarging request. In this case, the layer No. 3 is requested to the server. The low resolution server which receives such a request returns the URL of the high resolution server in accordance with a flowchart of FIG. 14. This is a response 22d in FIG. 13.

The plug-in software on the client side sees the response returned from the server machine. Since the URL has been returned at this time, the plug-in software forms a request again from the URL and issues the request to a new server. This is a request 23a in FIG. 13. After that, a response is returned from the high resolution server (response 23b).

After that, the operation such that a tile number of resolution necessary for the present display in the image data is request to the server in accordance with the operation of the user, specifically speaking, an enlargement, reduction, scroll, etc. and the data is displayed after it was received is repeated.

In the embodiment, since the high resolution server has accumulated the data of all layers, while the image data which is handled on the client side does not change, if an access point is changed from the low resolution server to the high resolution server, all of the subsequent processes can be executed by the high resolution server.

(Fourth Embodiment)

Although the high resolution server has the image data of all layers in the foregoing third embodiment, in the fourth embodiment, it is assumed that the high resolution server does not have the image data of the layer in the portion which is managed by the low resolution server.

In the description of the fourth embodiment, portions similar to those in the third embodiment are omitted. That is, the construction up to the portion where the request is issued to the high resolution server is similar to that of the third embodiment.

It is assumed that the user who uses the plug-in software on the client side makes a reducing request in this state. In this case, the request is made to the high resolution server.

FIG. 15 is a flowchart showing a procedure for a data transmitting process which is executed by the high resolution server at this time.

In the diagram, in step S41, whether the data of the layer requested by the client exists in its own machine or not is discriminated in a manner similar to step S31. If it exists, the data is transmitted to the client side in step S42. If it does not exist, the URL of the low resolution server stored in its own machine is sent in step S43. In the embodiment, since there is only one low resolution server, the URL which is returned in step S43 can be unconditionally determined.

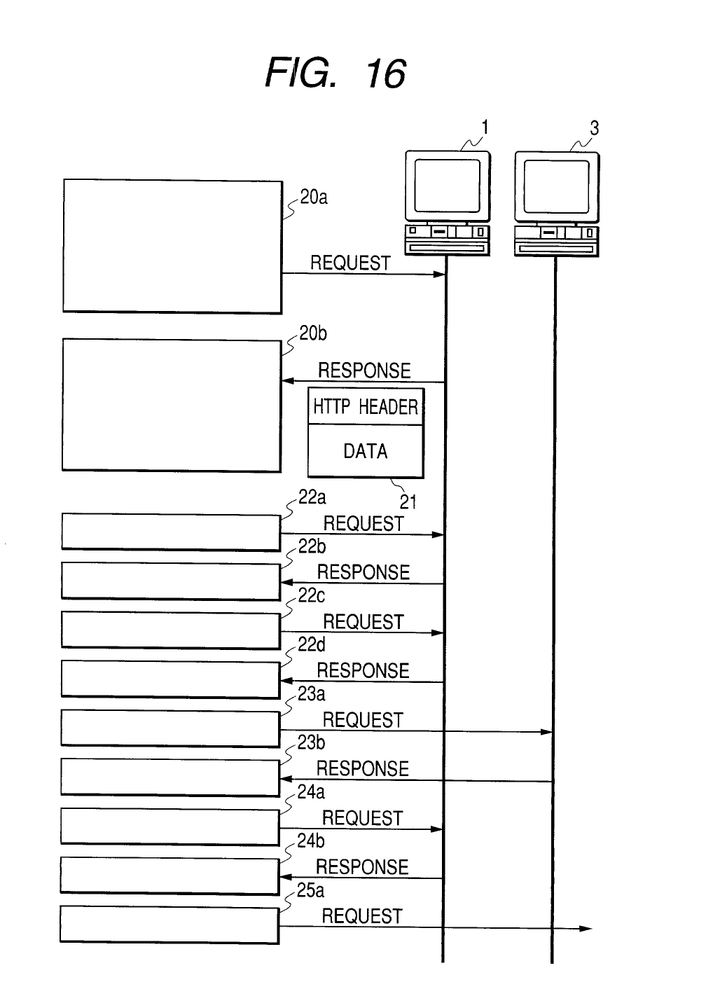

FIG. 16 is a diagram showing transition of the IIP at this time.

In the diagram, for example, it is assumed that the request responsive to the data of the layer on the low resolution side which is not managed by the high resolution server is issued in the request 23a. In this case, the high resolution server returns the URL of the low resolution server in accordance with a flowchart shown in FIG. 15 (response 23b).

The plug-in software which receives the URL operates so as to issue a request to the low resolution server (request 24a), receive the image data (response 24b), and display it. After that, if an enlargement display or the like is designated again, there is also a case where the low resolution server issues a request to another high resolution server different from the previous high resolution server in order to decide the high resolution server in accordance with the flowchart shown in FIG. 15. It is shown by a request 25a.

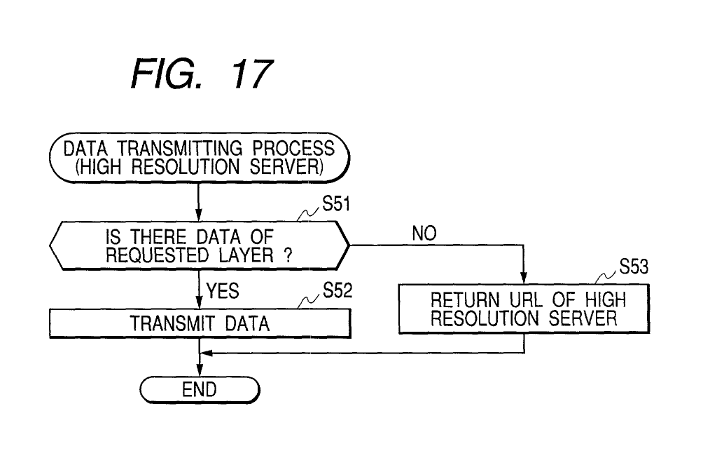

FIGS. 15 and 16 show the examples of the operation of the high resolution server. An example of the operation of the low resolution server is shown in a flowchart in FIG. 17. In this case, if it is determined that the data of the layer requested by the client does not exist (step S51), the URL of the high resolution server stored in its own machine is sent (step S53).

Even in the case where the enlargement and reduction of the same image data is repeated by the plug-in software on the client side, there is a case where the high resolution server which is used issues a request to a different high resolution server.

Although the case where the servers are divided into two kinds of groups of a high resolution group and a low resolution group has been described in the third and fourth embodiments, it is sufficient to execute similar processes even in the case where the servers are divided into three or more kinds of groups.

Although the case where the number of low resolution servers is equal to 1 has been described, if there are a plurality of low resolution servers, it is sufficient to provide one low resolution management server for managing the plurality of low resolution servers and select which low resolution server is used by the low resolution management server, or it is sufficient to form a homepage so that the client side can select which low resolution server is used.

Naturally, the objects of the invention are also accomplished by a method whereby a memory medium in which program codes of the software for realizing the functions of each of the embodiments mentioned above have been recorded is supplied to a system or an apparatus and a computer (or a CPU or an MPU) of the system or apparatus reads out the program codes stored in the memory medium and executes processes based on the program codes.

In this case, the program codes themselves read out from the memory medium realize the novel functions of the invention and the memory medium in which the program codes have been stored constructs the invention.

As a memory medium for supplying the program codes, for example, a floppy disk, a hard disk, an optical disk, a magnetooptic disk, a CD-ROM, a CD-R, a magnetic tape, a non-volatile memory card, an ROM, or the like can be used. The program codes can be also supplied from a server computer via a communication network.

Naturally, the invention incorporates not only a case where a computer executes the read-out program codes, so that the functions of each of the embodiments mentioned above are realized, but also a case where an OS or the like which operates on the computer executes a part or all of the actual processes on the basis of instructions of the program codes, and the functions of each of the embodiments mentioned above are realized by those processes.

Further, naturally, the invention also incorporates a case where the program codes read out from the memory medium are written into a memory provided for a function expanding board inserted into a computer or a function expanding unit connected to a computer and, thereafter, a CPU or the like provided for the function expanding board or the function expanding unit executes a part or all of the actual processes on the basis of instructions of the program codes, and the functions of each of the embodiments mentioned above are realized by those processes.

According to the invention, a plurality of server machines which manage the image data accumulated like a layer into the file are prepared, the request is sent to the plurality of server machines, in such a request, when a request to return the URL of the server is sent, the proper server is selected on the basis of the position of the client on the network and the position of each server on the network, and the URL of the selected server is returned to the client, so that the request of the client can be distributed to a plurality of servers. An effect such that by selecting the proper server, communication costs are reduced and a response speed to the request from the client side is raised is also obtained.

According to the invention, a plurality of server machines which manage the image data accumulated like a layer into the file are prepared, the request is sent to the plurality of server machines, in such a request, when a request to return the URL of the server is sent, the URLs or URIs of a plurality of servers or the URLs or URIs of a plurality of servers and their priority information are returned to the client, on the client side, by issuing the next request on the basis of a plurality of URLs or URIs sent from the server, the request of the client can be properly distributed to the plurality of servers.

Further, according to the invention, since the IIP server has the function for transmitting the URL at the time when the request is issued from the client side to the client side as it is, the IIP client can execute the subsequent processes by the client himself. Moreover, a person who develops a homepage that is released on the Internet can also easily form a page for displaying the Flashpix file.

Further, according to the invention, since the system has the function for dynamically switching the URL to be returned by the server side, the servers are divided into the high resolution servers which manage the high resolution data and the low resolution servers which manage the low resolution data, many high resolution servers in which the process for one request is heavy are arranged by the number of servers larger than that of the low resolution servers. Thus, the processes can be distributed and a high response speed to the request of the user can be realized.

By setting the number of low resolution servers which are used to 1, the high resolution servers can be also added without exercising an influence on the portion for developing the homepage.

What is claimed is:

1. An image data communication system comprising: a plurality of server computers for providing at least one of a plurality of stored image data; and at least one client computer for requesting one of said plurality of server computers to provide the image data,
wherein each of said server computers has
selecting means for, when said request is received from said client computer, selecting the server computer which can cope with said request and
transmitting means for transmitting access information for accessing said selected server computer to said client computer, and
said client computer has
obtaining means for, when said access information is received, obtaining the image data from the server computer corresponding to said access information.

2. A system according to claim 1, wherein when there are a plurality of said selected server computers, said selecting means selects the server computer to be accessed by said client computer on the basis of a positional relation between each of said selected server computers and said client computer on a network.

3. A system according to claim 1, wherein
said plurality of image data is data of a layer structure according to resolution, and
said selecting means selects the server computer to be accessed by said client computer on the basis of the resolution of the image data which is requested by said client computer.

4. A system according to claim 3, wherein
said plurality of server computers are classified into a low resolution group for storing the data of layers of low resolution and a high resolution group for storing the data of layers of high resolution, and
the server computer of said low resolution group or the server computer of said high resolution group stores the access information of at least one of the server computers of the other group.

5. A system according to claim 1, wherein when there are a plurality of said selected server computers, a plurality of access information each for accessing said server computer and priority information showing a priority of each of said access information are transmitted to said client computer.

6. A system according to claim 5, wherein said obtaining means selects one of said plurality of access information on the basis of said priority information and obtains the image data from the server computer corresponding to said selected access information.

7. A system according to claim 5, wherein
each of said image data is data-of a Flashpix image format, and
when a plurality of access information is selected from said received plurality of access information, even if a next request to be issued requests that one image data is provided, in the case where said image data is constructed by a plurality of image tiles, said obtaining means distributes and issues said request on an image tile unit basis of a ratio according to said priority information to said plurality of server computers corresponding to said plurality of selected access information.

8. An information processing apparatus in a system having a plurality of said information processing apparatuses for providing at least one of a plurality of stored image data, comprising:
memory means for storing access information for accessing its own apparatus and access information for accessing at least one of said plurality of information processing apparatuses except for its own apparatus;
receiving means for receiving a request of the image data from an external apparatus;
selecting means for selecting the information processing apparatus which can cope with said request from said plurality of information processing apparatuses; and
transmitting means for transmitting the access information for accessing the information processing apparatus selected by said selecting means to said external apparatus.

9. An apparatus according to claim 8, wherein when there are a plurality of said selected information processing apparatuses, said selecting means selects the information processing apparatus to be accessed by said external apparatus on the basis of a positional relation between each of said selected information processing apparatuses and said external apparatus on a network.

10. An apparatus according to claim 8, wherein
said plurality of image data is data of a layer structure according to resolution, and
said selecting means selects the information processing apparatus to be accessed by said external apparatus on the basis of the resolution of the image data which is requested by said information processing apparatus.

11. An apparatus according to claim 8, wherein
said plurality of information processing apparatuses are classified into a low resolution group for storing the data of layers of low resolution and a high resolution group for storing the data of layers of high resolution, and
the information processing apparatus of said low resolution group or the information processing apparatus of said high resolution group stores the access information of at least one of the information processing apparatuses of the other group.

12. An apparatus according to claim 8, wherein when there are a plurality of said selected information processing apparatuses, a plurality of access information each for accessing said information processing apparatus and priority information showing a priority of each of said access information are transmitted to said external apparatus.

13. An apparatus according to claim 12, wherein
each of said image data is data of a Flashpix image format, and
when a plurality of access information is selected from said received plurality of access information, even if a next request to be issued requests that one image data is provided, in the case where said image data is constructed by a plurality of image tiles, said obtaining means distributes and issues said request on an image tile unit basis of a ratio according to said priority information to said plurality of information processing apparatuses corresponding to said plurality of selected access information.

14. An information processing apparatus for providing at least one of a plurality of stored image data, comprising:
forming means for forming page data which is allowed to be displayed to a Web browser and has link information including first information for discriminating one of said plurality of image data and second information showing a request for access information for accessing the information processing apparatus which can provide the image data which is discriminated by said first information and
selecting means for transmitting said page data to an external apparatus and, thereafter, transmitting the access information for accessing one of the information processing apparatuses which can provide said image data to said external apparatus in accordance with a request for the image data based on said link information from said external apparatus.

15. An apparatus according to claim 14, wherein when there are a plurality of said selected information processing apparatuses, said selecting means selects the information processing apparatus to be accessed by said external apparatus on the basis of a positional relation between each of said selected information processing apparatuses and said external apparatus on a network.

16. An apparatus according to claim 14, wherein
said plurality of image data is data of a layer structure according to resolution, and
said selecting means selects the information processing apparatus to be accessed by said external apparatus on the basis of the resolution of the image data which is requested by said information processing apparatus.

17. An apparatus according to claim 14, wherein
said plurality of information processing apparatuses are classified into a low resolution group for storing the data of layers of low resolution and a high resolution group for storing the data of layers of high resolution, and
the information processing apparatus of said low resolution group or the information processing apparatus of said high resolution group stores the access information of at least one of the information processing apparatuses of the other group.

18. An apparatus according to claim 14, wherein
each of said image data is data of a Flashpix image format, and
said information processing apparatus and said external apparatus communicate the image data by an Internet Imaging Protocol.

19. An apparatus according to claim 14, wherein when there are a plurality of said selected information processing apparatuses, a plurality of access information each for accessing said information processing apparatus and priority information showing a priority of each of said access information are transmitted to said external apparatus.

20. An apparatus according to claim 19, wherein
each of said image data is data of a Flashpix image format, and
when a plurality of access information is selected from said received plurality of access information, even if a next request to be issued requests that one image data is provided, in the case where said image data is constructed by a plurality of image tiles, said obtaining means distributes and issues said request on an image tile unit basis of a ratio according to said priority information to said plurality of information processing apparatuses corresponding to said plurality of selected access information.

21. An image data communicating method in a system comprising: a plurality of server computers for providing at least one of a plurality of stored image data; and at least one client computer for requesting one of said plurality of server computers to provide the image data,
wherein each of said server computers has
a selecting step of, when said request is received from said client computer, selecting the server computer which can cope with said request and
a transmitting step of transmitting access information for accessing said selected server computer to said client computer, and
said client computer has
an obtaining step of, when said access information is received, obtaining the image data from the server computer corresponding to said access information.

22. A method according to claim 21, wherein in said selecting step, when there are a plurality of said selected server computers, the server computer to be accessed by said client computer is selected on the basis of a positional relation between each of said selected server computers and said client computer on a network.

23. A method according to claim 21, wherein
said plurality of image data is data of a layer structure according to resolution, and
in said selecting step, the server computer to be accessed by said client computer is selected on the basis of the resolution of the image data which is requested by said client computer.

24. A method according to claim 23, wherein
said plurality of server computers are classified into a low resolution group for storing the data of layers of low resolution and a high resolution group for storing the data of layers of high resolution, and
the server computer of said low resolution group or the server computer of said high resolution group stores the access information of at least one of the server computers of the other group.

25. A method according to claim 21, wherein when there are a plurality of said selected server computers, a plurality of access information each for accessing said server computer and priority information showing a priority of each of said access information are transmitted to said client computer.

26. A method according to claim 25, wherein in said obtaining step, one of said plurality of access information is selected on the basis of said priority information and the image data is obtained from the server computer corresponding to said selected access information.

27. A method according to claim 25, wherein
each of said image data is data of a Flashpix image format, and
in said obtaining step, when a plurality of access information is selected from said received plurality of access information, even if a next request to be issued requests that one image data is provided, in the case where said image data is constructed by a plurality of image tiles, said request is distributed and issued on an image tile unit basis of a ratio according to said priority information to said plurality of server computers corresponding to said plurality of selected access information.

28. An image communicating method in a system having a plurality of information processing apparatuses for providing at least one of a plurality of stored image data, comprising:
a reading step of reading out one of access information from a memory in which access information for accessing its own apparatus and access information for accessing at least one of said plurality of information processing apparatuses except for its own apparatus have been stored;
a receiving step of receiving a request of the image data from an external apparatus;
a selecting step of selecting the information processing apparatus which can cope with said request from said plurality of information processing apparatuses; and
a transmitting step of transmitting the access information for accessing the information processing apparatus selected by said selecting step to said external apparatus.

29. A method according to claim 28, wherein in said selecting step, when there are a plurality of said selected information processing apparatuses, the information processing apparatus to be accessed by said external apparatus is selected on the basis of a positional relation between each of said selected information processing apparatuses and said external apparatus on a network.

30. A method according to claim 28, wherein
said plurality of image data is data of a layer structure according to resolution, and
in said selecting step, the information processing apparatus to be accessed by said external apparatus is selected on the basis of the resolution of the image data which is requested by said information processing apparatus.

31. A method according to claim 28, wherein
said plurality of information processing apparatuses are classified into a low resolution group for storing the data of layers of low resolution and a high resolution group for storing the data of layers of high resolution, and
the information processing apparatus of said low resolution group or the information processing apparatus of said high resolution group stores the access information of at least one of the information processing apparatuses of the other group.

32. A method according to claim 28, wherein when there are a plurality of said selected information processing apparatuses, a plurality of access information each for accessing said information processing apparatus and priority information showing a priority of each of said access information are transmitted to said external apparatus.

33. A method according to claim 32, wherein
each of said image data is data of a Flashpix image format, and
in said obtaining step, when a plurality of access information is selected from said received plurality of access information, even if a next request to be issued requests that one image data is provided, in the case where said image data is constructed by a plurality of image tiles, said request is distributed and issued on an image tile unit basis of a ratio according to said priority information to said plurality of information processing apparatuses corresponding to said plurality of selected access information.

34. An information processing method of providing at least one of a plurality of stored image data, comprising:
a forming step of forming page data which is allowed to be displayed to a Web browser and has link information including first information for discriminating one of said plurality of image data and second information showing a request for access information for accessing the information processing apparatus which can provide the image data which is discriminated by said first information; and
a selecting step of transmitting said page data to an external apparatus and, thereafter, transmitting the access information for accessing one of the information processing apparatuses which can provide said image data to said external apparatus in accordance with a request for the image data based on said link information from said external apparatus.

35. A method according to claim 34, wherein in said selecting step, when there are a plurality of said selected information processing apparatuses, the information processing apparatus to be accessed by said external apparatus is selected on the basis of a positional relation between each of said selected information processing apparatuses and said external apparatus on a network.

36. A method according to claim 34, wherein
said plurality of image data is data of a layer structure according to resolution, and
in said selecting step, the information processing apparatus to be accessed by said external apparatus is selected on the basis of the resolution of the image data which is requested by said information processing apparatus.

37. A method according to claim 34, wherein
said plurality of information processing apparatuses are classified into a low resolution group for storing the data of layers of low resolution and a high resolution group for storing the data of layers of high resolution, and
the information processing apparatus of said low resolution group or the information processing apparatus of said high resolution group stores the access information of at least one of the information processing apparatuses of the other group.

38. A method according to claim 34, wherein
each of said image data is data of a Flashpix image format, and
said information processing apparatus and said external apparatus communicate the image data by an Internet Imaging Protocol.

39. A method according to claim 34, wherein when there are a plurality of said selected information processing apparatuses, a plurality of access information each for accessing said information processing apparatus and priority information showing a priority of each of said access information are transmitted to said external apparatus.

40. A method according to claim 39, wherein
each of said image data is data of a Flashpix image format, and
in said obtaining step, when a plurality of access information is selected from said received plurality of access information, even if a next request to be issued requests that one image data is provided, in the case where said image data is constructed by a plurality of image tiles, said request is distributed and issued on an image tile unit basis of a ratio according to said priority information to said plurality of information processing apparatuses corresponding to said plurality of selected access information.

41. A computer program which is executed by a computer of an information processing apparatus for providing at least one of a plurality of stored image data, comprising:
a forming step of forming page data which is allowed to be displayed to a Web browser and has link information including first information for discriminating one of said plurality of image data and second information showing a request for access information for accessing the information processing apparatus which can provide the image data which is discriminated by said first information; and
a selecting step of transmitting said page data to an external apparatus and, thereafter, transmitting the access information for accessing one of the information processing apparatuses which can provide said image data to said external apparatus in accordance with a request for the image data based on said link information from said external apparatus.

42. A program according to claim 41, wherein in said selecting step, when there are a plurality of said selected information processing apparatuses, the information processing apparatus to be accessed by said external apparatus is selected on the basis of a positional relation between each of said selected information processing apparatuses and said external apparatus on a network.

43. A program according to claim 41, wherein
said plurality of image data is data of a layer structure according to resolution, and
in said selecting step, the information processing apparatus to be accessed by said external apparatus is selected on the basis of the resolution of the image data which is requested by said information processing apparatus.

44. A computer-readable memory medium which stores a computer program according to claim 41.

45. A computer-readable memory medium which stores a computer program according to claim 42.

46. A computer-readable memory medium which stores a computer program according to claim 43.
